(19) United States
(12) Patent Application Publication
(10) Pub. No.: US 2016/0147315 A1
(43) Pub. Date: May 26, 2016

(54) HAND-HELD COMPUTER INTERFACE AND HEATING CIRCUIT

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: XI-HUAI HE, Wuhan (CN); XUN-YU XIAO, Wuhan (CN); CHUN-SHENG CHEN, New Taipei (TW)

(21) Appl. No.: 14/587,661

(22) Filed: Dec. 31, 2014

(30) Foreign Application Priority Data
Nov. 26, 2014 (CN) 201410703344.9

(51) Int. Cl. G06F 3/039; H05B 3/06; G06F 3/0354; H05B 3/00

(52) U.S. Cl. CPC G06F 3/039; H05B 3/0014; H05B 3/06; G06F 3/03543

(57) ABSTRACT

A hand-held computer interface includes a body having an exterior surface and defining an interior space, a hand controlled computer input device contained substantially within the body interior space, a heating unit positioned within the interior space, a control unit positioned within the body, the control unit having a control pin and at least one output pin coupled to the heating unit, and a switch unit positioned within the body, the switch unit coupled to the control pin. The switch unit has two or more switch positions and at least one of the two or more switch positions activates the control unit to supply electrical power to the heating unit. When electrical power is supplied to the heating unit, the exterior surface of the body is heated.

### FIELD

The subject matter herein generally relates to a hand-held computer interface with a heating circuit therein.

### BACKGROUND

Some hand-held computer interfaces, such as computer mouses, a heated computer mouse pad or computer mouse sheath is generally used to prevent a cold feeling when users touch a computer mouse in winter.

### BRIEF DESCRIPTION OF THE DRAWINGS

Implementations of the present technology will now be described, by way of example only, with reference to the attached figures.

FIG. 1 is a block diagram of an embodiment of a hand-held computer interface in a computer mouse.

FIG. 2 is a circuit diagram of an embodiment of a heating circuit in the hand-held computer interface of FIG. 1.

FIG. 3 is a circuit diagram of the heating circuit of FIG. 2 coupled to a USB connector.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

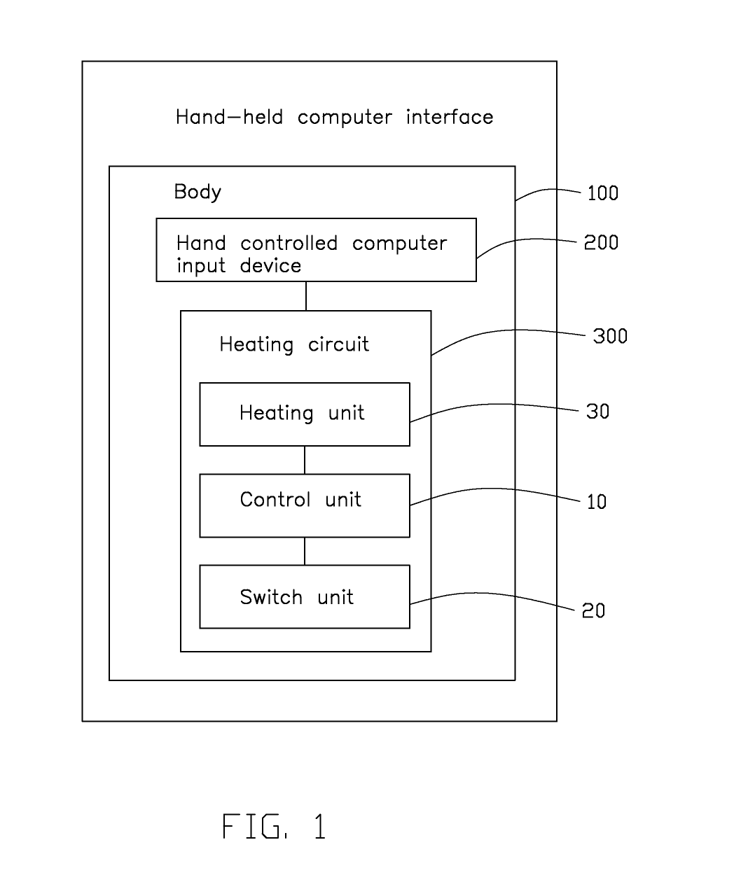

FIG. 1 illustrates a hand-held computer interface in accordance with an embodiment. The hand-held computer interface can include a body 100 having an exterior surface and defining an interior space, a hand controlled computer input device 200 contained substantially within the body interior space, and a heating circuit 300 positioned within the interior space. In at least one embodiment, the hand-held computer interface is a computer mouse.

The heating circuit 300 can include a control unit 10, a switch unit 20, and a heating unit 30.

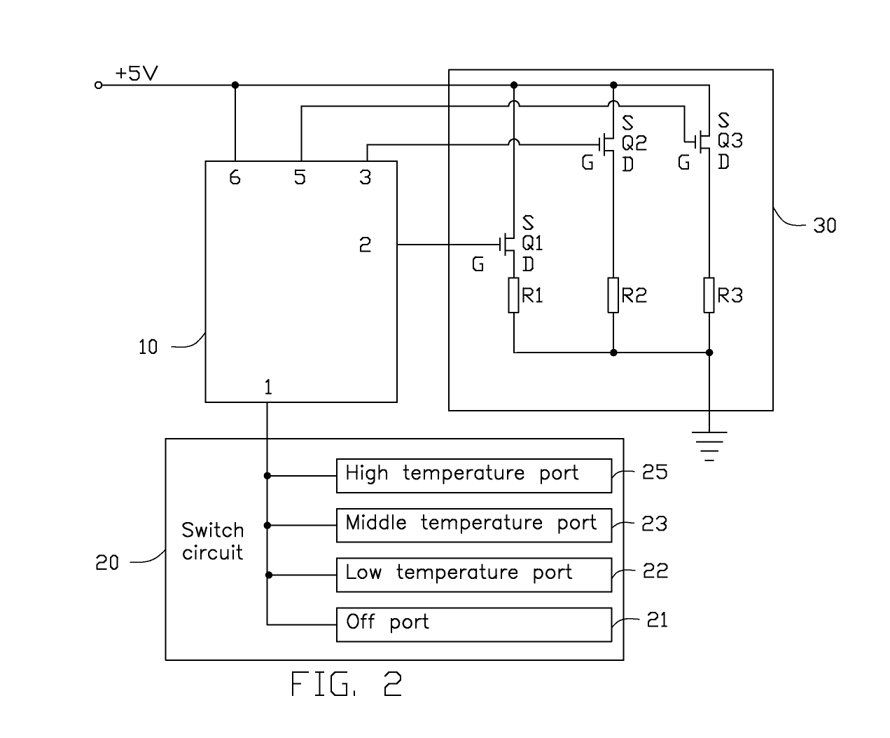

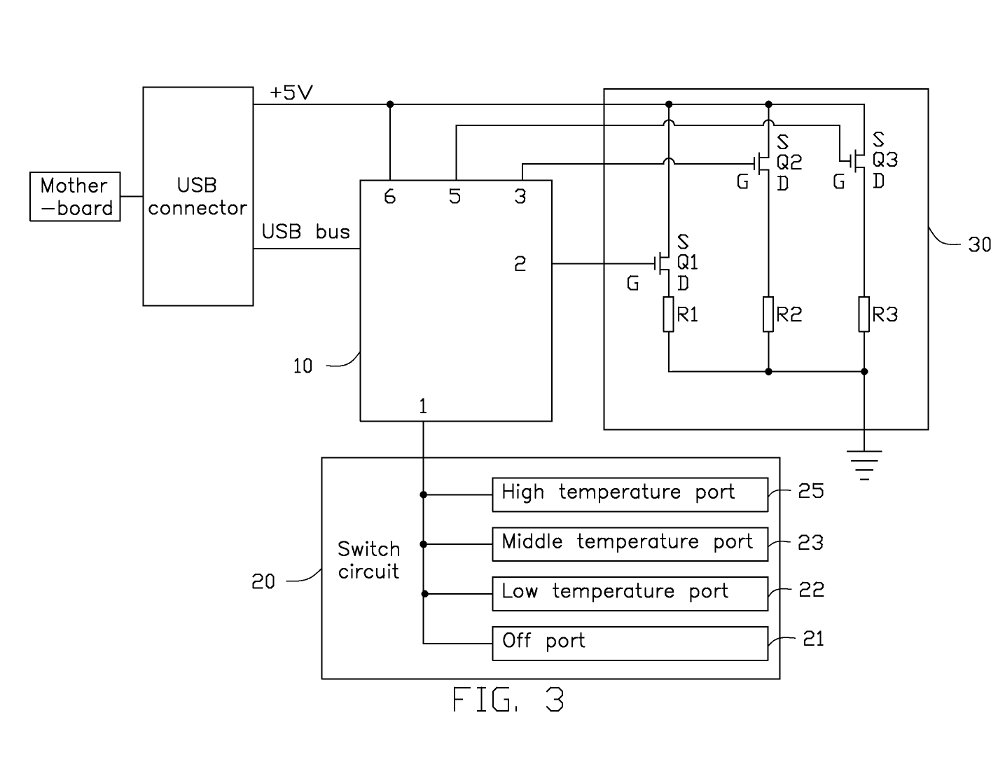

FIG. 2 and FIG. 3 illustrate that the control unit 10 has a control pin 1, a first output pin 2, a second output pin 3, a third output pin 5, and a power pin 6.

The power pin 6 is configured to receive a +5V operation voltage. In at least one embodiment, the operation voltage is from a power port of a USB connector of the computer mouse. The power port receives an output voltage output from a motherboard of an electronic device. The computer mouse can be coupled to the electronic device via the USB connector. The control unit 10 is coupled to the USB connector via a USB bus.

The control pin 1 is coupled to the switch unit 20. The switch unit 20 is configured to switch the heating unit 30 on/off. The switch unit 20 can include an off port 21, a low temperature port 22, a middle temperature port 23, and a high temperature port 25. When the switch unit 20 switches on the low temperature port 22 or the middle temperature port 23 or the high temperature port 25, the heating unit 30 is switched on. When the switch unit 20 switches on the off port 21, the heating unit 30 is switched off. In at least one embodiment, the switch unit 20 is a paddle switch.

The heating unit 30 can include a first heating resistor R1, a second heating resistor R2, a third heating resistor R3, a first field-effect tube (FET) Q1, a second FET Q2, and a third FET Q3.

A first port of the first resistor R1 is grounded, a second port of the first resistor R1 is coupled to the drain electrode D of the first FET Q1. The grid electrode G of the first FET Q1 is coupled to the first output pin 2. The source electrode S of the first FET Q1 is coupled to the power port.

A first port of the second resistor R2 is grounded, a second port of the second resistor R2 is coupled to the drain electrode D of the second FET Q2. The grid electrode G of the second FET Q2 is coupled to the second output pin 3. The source electrode S of the second FET Q2 is coupled to the power port.

A first port of the third resistor R3 is grounded, a second port of the third resistor R3 is coupled to the drain electrode D of the third FET Q3. The grid electrode G of the third FET Q3 is coupled to the third output pin 5. The source electrode S of the third FET Q3 is coupled to the power port.

When the switch unit 20 switches on the low temperature port 22, the control pin 1 sends out a control signal to control the first output pin 2 to output a high level voltage, and the second output pin 3 and the third output pin 5 outputs a low level voltage. Thus, the first FET Q1 is switched on, and the second FET Q2 and the third FET Q3 are switched off. The first heating resistor R1 is operated to generate heat in the computer mouse, enabling a palm touching the computer mouse to feel warm.

When the switch unit 20 switches on the middle temperature port 23, the control pin 1 sends out a control signal to control the first output pin 2 and the second output pin 3 to output a high level voltage, and the third output pin 5 outputs a low level voltage. Thus, the first FET Q1 and the second FET Q2 are switched on, and the third FET Q3 is switched off. The first heating resistor R1 and the second heating resistor R2 are operated to generate heat in the computer mouse. In this position, the first resistor R1 is coupled to the second resistor R2 in parallel, a total resistance R0 is smaller than R1, according to the power formula P=U²/R, a heating power is greater than that when the switch unit 20 switches on the low temperature port 21.

When the switch unit 20 switches on the high temperature port 25, the control pin 1 sends out a control signal to control the first output pin 2, the second output pin 3, and the third output pin 5 to output a high level voltage. Thus, the first FET Q1, the second FET Q2, and the third FET Q3 are switched on. The first heating resistor R1, the second heating resistor R2, and the third heating resistor R3 are operated to generate heat in the computer mouse. In this position, the first resistor R1, the second resistor R2, and the third resistor R3 are coupled to each other in parallel, a total resistance is smaller than R0, according to the power formula P=U²/R, a heating power is greater than that when the switch unit 20 switches on the middle temperature port 23.

When the switch unit 20 switches on the off port 21, the control pin 1 sends out a control signal to control the first output pin 2, the second output pin 3, and the third output pin 5 to output a low level voltage. Thus, the first FET Q1, the second FET Q2, and the third FET Q3 are switched off. The first heating resistor R1, the second heating resistor R2, and the third heating resistor R3 are not operated to generate heat in the computer mouse.

The embodiments shown and described above are only examples. Many details are often found in the art such as the other features of a hand-held computer interface and a heating circuit. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A hand-held computer interface comprising:
a body having an exterior surface and defining an interior space;
a hand controlled computer input device contained substantially within the body interior space;
a heating unit positioned within the interior space;
a control unit positioned within the body, the control unit having a control pin and at least one output pin coupled to the heating unit; and
a switch unit positioned within the body, the switch unit coupled to the control pin;
wherein, the switch unit has two or more switch positions and at least one of the two or more switch positions activates the control unit to supply electrical power to the heating unit; and
wherein, when electrical power is supplied to the heating unit, the exterior surface of the body is heated.

2. The hand-held computer interface of claim 1, wherein the heating unit comprising a plurality of heating resistors coupled to each other in parallel, and the heating unit generates heat by the heating resistors.

3. The hand-held computer interface of claim 2, wherein each heating resistor is coupled to one of the output pins via a field-effect tube (FET), the control pin controls the output pin to output a high/low level signal to switch the FET on/off.

4. The hand-held computer interface of claim 3, wherein a first port of each heating resistor is grounded, and a second port of each heating resistor is coupled to the drain electrode of the FET, the grid electrode of the FET is coupled to the output pin, and the source electrode is coupled to a direct current voltage.

5. The hand-held computer interface of claim 4, wherein the control unit further has a power pin, and the power pin is coupled to a power port of a USB connector.

6. The hand-held computer interface of claim 5, wherein the source electrode of each FET is coupled to the power pin.

7. The hand-held computer interface of claim 3, wherein the switch unit has different temperature ports, when each of the different temperature ports is switched on, different number of heating resistors are operated to generate different temperatures.

8. The hand-held computer interface of claim 7, wherein the switch unit further has an off port, when the off port is switched on, the control pin controls the output pins to cut off the FETs.

9. The hand-held computer interface of claim 7, wherein the switch unit is a paddle switch.

10. The hand-held computer interface of claim 3, wherein each FET is N-type FET.

11. A heating circuit in a hand-held computer interface, comprising:
a control unit having a control pin and at least one output pin;
a switch unit coupled to the control pin; and
a heating unit coupled to the output pin;
wherein the switch unit is operable to control the output pin to switch the heating unit on via the control pin, enabling the heating unit to generate heat for an exterior surface of the hand-held computer interface.

12. The heating circuit of claim 11, wherein the heating unit comprising a plurality of heating resistors coupled to each other in parallel, and the heating unit generates heat by the heating resistors.

13. The heating circuit of claim 12, wherein each heating resistor is coupled to one of the output pins via a field-effect tube (FET), the control pin controls the output pin to output a high/low level signal to switch the FET on/off.

14. The heating circuit of claim 13, wherein a first port of each heating resistor is grounded, and a second port of each heating resistor is coupled to the drain electrode of the FET, the grid electrode of the FET is coupled to the output pin, and the source electrode is coupled to a direct current voltage.

15. The heating circuit of claim 14, wherein the control unit further has a power pin, and the power pin is coupled to a power port of a USB connector.

16. The heating circuit of claim 15, wherein the source electrode of each FET is coupled to the power pin.

17. The heating circuit of claim 13, wherein the switch unit has different temperature ports, when each of the different temperature ports is switched on, different number of heating resistors are operated to generate different temperatures.

18. The heating circuit of claim 17, wherein the switch unit further has an off port, when the off port is switched on, the control pin controls the output pins to cut off the FETs.

19. The heating circuit of claim 17, wherein the switch unit is a paddle switch.

20. A heating circuit in a hand-held computer interface, comprising:
a control unit having a power pin configured to couple to a power port of a USB connector; and
a heating unit coupled to the power pin;
wherein the power pin is operable to supply power for the heating unit to generate heat for an exterior surface of the hand-held computer interface.
